(19) United States
(12) Patent Application Publication
(10) Pub. No.: US 2013/0098746 A1
(43) Pub. Date: Apr. 25, 2013

(54) KEY AND ELECTRONIC DEVICE USING THE SAME

(71) Applicants: PING LI, Shenzhen City (CN); XUE-FENG WAN, Shenzhen City (CN)

(72) Inventors: PING LI, Shenzhen City (CN); XUE-FENG WAN, Shenzhen City (CN)

(73) Assignees: Hon Hai Precision Industry Co., Ltd., Tu-Cheng (TW); Hong Fu Jin Precision Industry (ShenZhen) Co., Ltd, Shenzhen City (TW)

(21) Appl. No.: 13/531,073

(22) Filed: Jun. 22, 2012

(30) Foreign Application Priority Data
Oct. 19, 2011 (CN) 201120399048.6

(51) Int. Cl. H01H 13/02

(52) U.S. Cl. 200/522; 200/341

(57) ABSTRACT

An electronic device includes a housing, and a key fixed to the housing. The key comprises a key cap fixed to the housing, a trigger component protruded from a surface of the key cap. The trigger component defines at least one recessed portion, the at least one recessed portion extends from one end of the trigger component away from the key cap to the other end of the trigger component from which the trigger component extends.

### BACKGROUND

1. Technical Field

The present disclosure relates to electronic devices; and more particularly, to an electronic device having a key.

2. Description of Related Art

Electronic devices, such as DVD players, may have a plurality of keys for receiving users' operations. Each key includes a key cap and a trigger component for triggering the corresponding switch arranged on the circuit board. The trigger component protrudes from a surface of the key cap, and the portion of the key cap where the trigger component protrudes may be thicker than other portions of the key cap, which may be easily deformed during the molding process.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partially exploded view of an electronic device having a key.

FIG. 2 is a partially enlarged view of the key of FIG. 1.

### DETAILED DESCRIPTION

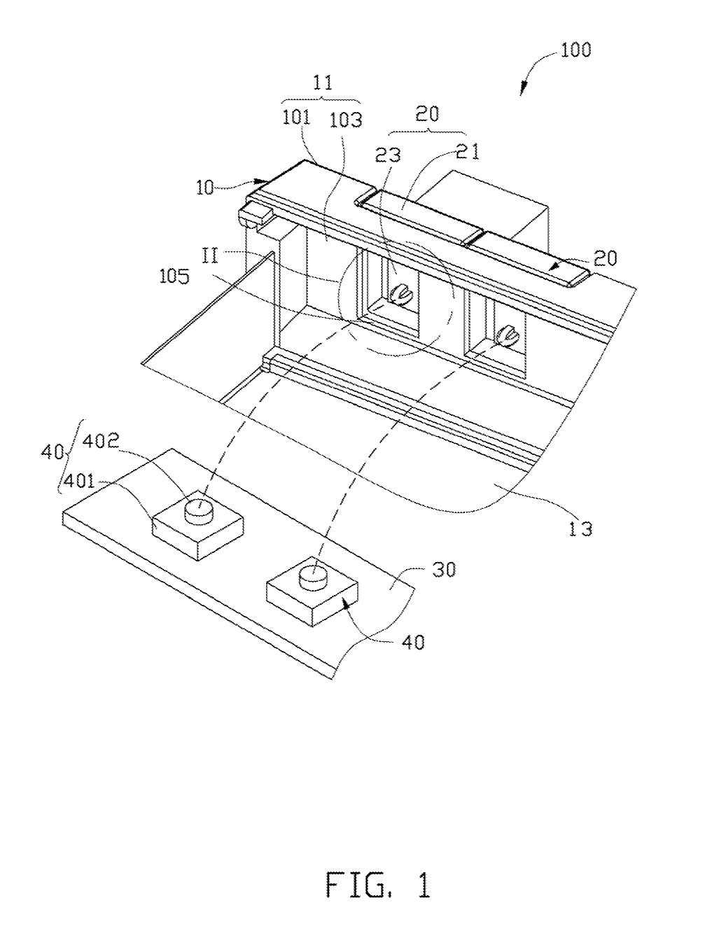

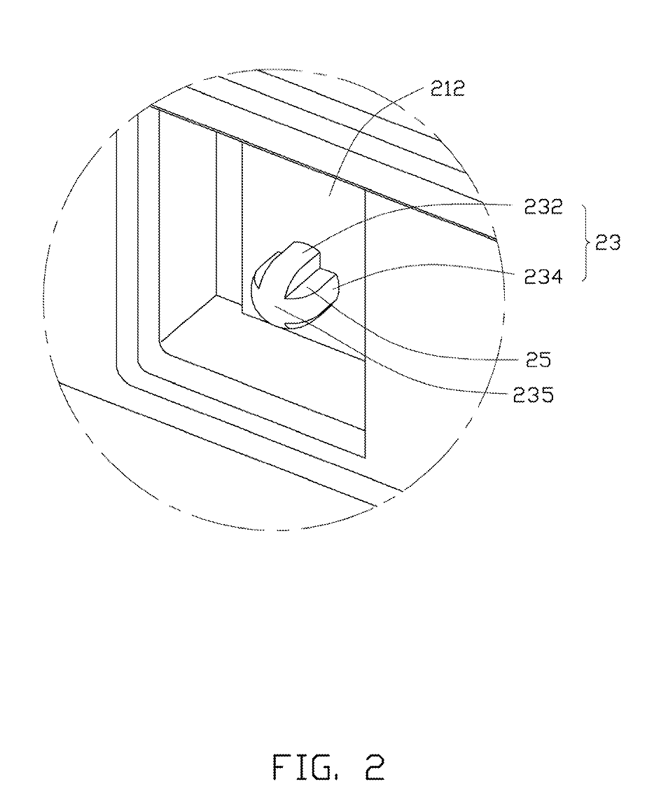

Referring to FIG. 1, an electronic device 100 includes a housing 10 (partially shown in FIGS. 1 and 2), two keys 20 fixed to the housing 10, a circuit board 30 received in the housing 10, and two spaced apart switches 40. The two switches 40 are mounted on the circuit board 30 and correspond to the two keys 20 respectively. The electronic device 100 may be a DVD player, a computer, or other electronic device. In the illustrated embodiment, the electronic device 100 is a DVD player.

The housing 10 includes a lower cover 13 and a plurality of sidewalls connecting to the lower cover 13. One of the sidewalls (referred herein as the first sidewall 11) perpendicularly connecting with the lower cover 13 includes an outer surface 101, and an inner surface 103. The first sidewall 11 defines two through holes 105 for engaging with the two keys 20 respectively. The circuit board 30 is fixed to the lower cover 13, and is substantially parallel to the first sidewall 11.

Referring to FIG. 2, the keys 20 are secured to the first sidewall 11 for actuating the corresponding switch 40 when pressed. Each key 20 includes a key cap 21, a trigger component 23, and a restoring component (not shown). The restoring component is arranged between the circuit board 30 and the key cap 21 to provide a restoring force for returning the key cap 21 to its initial position when the corresponding keycap 21 is released.

The key cap 21 is fixed to the first sidewall 11, and includes a first surface (not labeled) substantially coplanar with the outer surface 101, and a second surface 212 opposite to the first surface. When viewed from the outer surface 101 of the first sidewall 11, the first surface is visible, and the second surface 212 is hidden in the housing 10.

The trigger component 23 perpendicularly protrudes from the second surface 212 of the key cap 21 and is received in the through hole 105. Four portions of the trigger component 23 are cut away to form four recessed portions 25. Each recessed portion 25 extends from an end of the trigger component 23 away from the key cap 21 to the other end of the trigger component 23 from which the trigger component 23 extends. In the embodiment, the recessed portions 25 are evenly spaced from each other, such that the trigger component 23 is substantially cross-shaped. The trigger component 23 includes two perpendicular cross portions 232 and 234, and each recessed portion 25 is formed between two adjacent cross portions 232 and 234. Because of the recessed portions 25, contacting area of the trigger portion 23 with the keycap 21 is diminished. Thus reducing the pull force applied to the key cap 21 and preventing the key cap 21 from deforming during the mold process. It is noteworthy that the number, the shape, and the size of the recessed portions 25 may be changed according to need.

In addition, the trigger component 23 further includes a contacting portion 235. The contacting portion 235 is formed on an end of the trigger component 23 away from the key cap 21, and is substantially semispherical.

Further referring to FIG. 1, the switches 40 are mounted on the circuit board 30 and correspond to the keys 20. The switches 40 are activated when being pressed by the corresponding keys 20. Each switch 40 includes a main body 401 and a trigger portion 402 engaging with the contacting portion 235. The trigger portion 402 is substantially column shaped, and protrudes from a surface of the main body 401 opposite to the circuit board 30. In the illustrated embodiment, the surface facing the contacting portion 235 of the trigger portion 402 is flat.

When the circuit board 30 is fixed to the first sidewall 11, the trigger component 23 engages with the trigger portion 402 with the contacting portion 235 and the trigger portion 23 contacting each other. When an external force is applied to the key cap 21, the trigger component 23 is driven to actuate the trigger portion 402 for triggering the switch 40. Because the contacting manner of the contacting portion 235 and the trigger portion 402 is point-to-surface, the force applied to the trigger portion 402 is more centralized, and the contacting between the trigger component 23 and the trigger portion 402 becomes more sensitive,

Although information and the advantages of the present embodiments have been set forth in the foregoing description, together with details of the structures and functions of the present embodiments, the disclosure is illustrative only; changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a housing; and
a key fixed to the housing, the key comprises a key cap secured to the housing and a trigger component extending from a surface of the key cap;
wherein the trigger component defines at least one recessed portion, the at least one recessed portion extends from one end of the trigger component away from the key cap to the other end of the trigger component from which the trigger component extends.

2. The electronic device as claimed in claim 1, wherein the trigger component is cross-shaped, and comprises two perpendicular cross portions.

3. The electronic device as claimed in claim 2, wherein the at least one recessed portion forms between two adjacent cross portions.

4. The electronic device as claimed in claim 3, wherein the trigger component defines four recessed portions evenly spaced from each other.

5. The electronic device as claimed in claim 1, wherein the trigger component comprises a contacting portion, the contacting portion is a hemispherical-shaped, and forms on an end of the trigger component opposite to the key cap.

6. The electronic device as claimed in claim 5, wherein the electronic device comprises a circuit board received in the housing and a switch secured to the circuit board, the switch contacts with the contacting portion and is activated when the key is pressed.

7. The electronic device as claimed in claim 6, wherein the switch comprises a trigger portion corresponding to the contacting portion, the surface facing the contacting portion of the trigger portion is flat, when the key is pressed, the contacting portion is contacted with the trigger portion.

8. An electronic device, comprising:
a housing; and
a key fixed to the housing, the key comprises a key cap secured to the housing and a trigger component extending from a surface of the key cap;
wherein the trigger component comprises a hemispherical-shaped contacting portion, the contacting forms on an end opposite to the key cap of the trigger component.

9. The electronic device as claimed in claim 1, wherein the electronic device comprises a circuit board received in the housing and a switch secured to the circuit board, the switch contacts with the contacting portion and is conducted when the key is pressed.

10. The electronic device as claimed in claim 9, wherein the switch comprises a trigger portion corresponding to the contacting portion, the surface facing the contacting portion of the trigger portion is flat, when the switch is contacted with the trigger component, the contacting manner of the contacting portion and the trigger portion is point-to-surface.

11. The electronic device as claimed in claim 8, wherein the trigger component defines at least one recessed portion, the at least one recessed portion extends from one end of the trigger component away from the key cap to the other end of the trigger component from which the trigger component extends.

12. The electronic device as claimed in claim 11, wherein the trigger component is cross-shaped, and comprises two perpendicular cross portions.

13. The electronic device as claimed in claim 12, wherein the at least one recessed portion forms between two adjacent cross portions.

14. The electronic device as claimed in claim 13, wherein the trigger component defines four recessed portions evenly spaced from each other.

15. A key of an electronic device, the electronic device comprising a housing for fixing the key, the key comprising:
a key cap secured to the housing; and
a trigger component protruded from a surface of the key cap;
wherein the trigger component defines at least one recessed portion, the at least one recessed portion extends from one end of the trigger component away from the key cap to the other end of the trigger component from which the trigger component extends.

16. The key as claimed in claim 15, wherein the trigger component is cross-shaped, and comprises two perpendicular cross portions.

17. The key as claimed in claim 16, wherein the at least one recessed portion forms between two adjacent cross portions.

18. The key as claimed in claim 17, wherein the tripper component defines four recessed portions evenly spaced from each other.

19. The key as claimed in claim 15, wherein the trigger component comprises a contacting portion, the contacting portion is a hemispherical-shaped, and forms on an end of the trigger component opposite to the key cap.

20. The key as claimed in claim 19, wherein the electronic device comprises a circuit board received in the housing and a switch secured to the circuit board, the switch comprises a trigger portion corresponding to the contacting portion, the surface facing the contacting portion of the trigger portion is flat, when the key is pressed, the contacting portion is contacted with the trigger portion.
